(19) United States
(12) Patent Application Publication
(10) Pub. No.: US 2005/0145408 A1
(43) Pub. Date: Jul. 7, 2005

(54) Electronic component

(76) Inventor: Scott Hess, Lake in the Hills, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/003,082

(22) Filed: Dec. 3, 2004

Related U.S. Application Data
(60) Provisional application No. 60/526,478, filed on Dec. 3, 2003.

(51) Int. Cl. H02G 3/08

(52) U.S. Cl. 174/52.1

(57) ABSTRACT

A low profile surface mountable inductive component having an elongated core having first and second ends and first and second supports for supporting the core. Metalized pads are provided on the supports for electrically connecting and mounting the supports to a printed circuit board, and a wire is wound about at least a portion of the core with the wire ends being electrically connected to the metalized pads of the supports. In one form, the core and supports define a chip form having a length ranging from 0.2 mm to 0.8 mm, a width ranging from 0.1 mm to 0.6 mm, and a height ranging from 0.2 mm to 0.6 mm. In another form, the component has a cover covering at least a portion of the wire winding and the component has a length ranging from 0.2 mm to 1.0 mm, a width ranging from 0.2 mm to 0.7 mm, and a height ranging from 0.2 mm to 0.7 mm.

### CROSS-REFERENCE TO RELATED APPLICATION

This application claims the benefit of U.S. Provisional Application No. 60/526,478, filed Dec. 3, 2003, which is hereby incorporated herein by reference in its entirety.

### BACKGROUND OF THE INVENTION

This invention relates generally to electronic components and more particularly concerns low profile surface mountable inductive components which have smaller dimensions but perform comparable to larger inductive components.

The electronics industry is continually called upon to make products smaller and more powerful. Applications such as mobile phones, portable computers, computer accessories, hand-held electronics, etc., create a large demand for smaller electronic components. These applications further drive technology to research new areas and ideas with respect to miniaturizing electronics. Often times, applications specifically require “low profile” components due to constraints in height and width. Unfortunately, the technology is often limited due to the inability to make certain components smaller, faster, or more powerful. Nowhere can this be seen more than in the struggle to manufacture smaller electronic components and circuits.

Originally, components were mounted on a printed circuit board (PCB) by inserting the leads of the component through the PCB and soldering them to solder pads on the opposite side of the PCB, (called through-hole technology). This technique left half of the PCB unpopulated because one side had to be reserved for solder pads and solder. Therefore, in order to fit more components in a particular circuit, the PCBs were made larger, or additional PCBs were required. Many times, however, these options were not available due to constraints in size for the PCBs.

The solution to this problem came in the form of Surface-Mount Devices (SMD), or Surface-Mount Technology. SMDs allow electrical components to be mounted on one side of a PCB, (i.e., without having the leads inserted through-holes). An SMD device has small metalized pads (solder pads or leads) connected to its body, which correspond to solder pads or lands placed on the surface of the PCB. Typically the PCB is run through a solder-paste machine (or screen printer), which puts a small amount of solder on the solder pads on the PCB. A glue dot may also be inserted on the PCB where the component is to rest in order to assist in retaining the component in position. Then, the component is placed on the PCB (held by the glue dot-if applied), and the PCB is sent through a re-flow oven to heat the solder paste and solder the component leads to the PCB solder pads. The primary advantage to this technique is that both sides of the PCB can now be populated by electronic components. Meaning one PCB today can hold an amount of electrical components equal to two PCBs in the past.

As a result of this advancement in technology, the current electronic circuits are mainly limited by the size of components used on the PCB. Meaning, if the electronic components are made smaller, the circuits can be made smaller as well. Unfortunately, there are some electronic components that can simply not be produced any smaller than they currently are without sacrificing something, (e.g., performance, structural integrity, etc.). Usually this is because the desired parameters for the component cannot be achieved when using smaller parts. A good example of this is inductive components. Certain parameters of these components are affected by the size of parts used. For instance, in inductors, wire gauge determines both the DC resistance and the current carrying ability of the component. In other examples, the component may be capable of being made in a smaller size, but incapable of performing comparably to the original larger version of the component, (e.g., with comparable inductance, frequency range, Q-value, self-resonant frequency, or the like).

In FIG. 8A, a powerful chip inductor known in the art as the Coilcraft® 0402 Series Chip Inductor, is illustrated. This chip inductor has a length of 1.19 mm, a width of 0.635 mm and a height of 0.66 mm. (Note: the dimensions illustrated in the attached drawings are in inches rather than millimeters). Furthermore, as illustrated in FIG. 8B, the chip inductor has a core and supports which define a dog bone or dumbbell shaped chip form, which has a length of 1.02 mm, width of 0.51 mm and a height of 0.51 mm. The component may be provided in inductances between 1-100 nH and with a Q-value ranging between 31-77 (at 900 MHz) or 32-100 (at 1.7 GHz). Although the performance parameters of this component are attractive, the size of the component may prevent it from being used in certain applications, such as densely populated circuits and/or products having limited space on the PCB for placing such components.

In order to maintain the 0402 Series Chip Inductor's performance parameters, the component cannot simply be reduced in size. For example, if the component's dimensions are simply reduced by 25%, the component will not be able to provide a range of inductance, frequency, Q-values, and self-resonant frequency values which are comparable to the original 0402 Series Chip Inductor. As a specific example, the component will not be able to reach the higher inductance values specified in the range of the 0402 Series Chip Inductor because the number of turns of the wire winding will be reduced due to the reduced size of the component. The inability to reach these inductance values will reduce the number of applications the component can be used in and may make the component insufficient for use in any electrical circuit.

Accordingly, it has been determined that the need exists for an improved electronic component which overcomes the aforementioned limitations and which further provides capabilities, features and functions, not available in current devices.

### BRIEF DESCRIPTION OF THE DRAWINGS

Other objects and advantages of the invention will become apparent upon reading the following detailed description and upon reference to the drawings, in which:

FIGS. 1A-B are side elevational and bottom views, respectively, of an electronic component according to the invention;

FIGS. 2A-B are perspective views of embodiments of the electronic component from FIG. 1, shown with a C-shape core assembly and an H-shape core assembly, respectively;

FIGS. 2C-D are perspective views of the chip forms from FIGS. 2A-B, illustrating the C-shape core assembly and H-shape core assembly, respectively;

FIGS. 3A-B are perspective views of alternate embodiments of the electronic component from FIG. 1, shown with an H-shape core assembly and a C-shape core assembly, respectively;

FIGS. 3C-D are perspective views of the chip forms from FIGS. 3A-B, illustrating the H-shape core assembly and C-shape core assembly, respectively;

FIG. 4A is a perspective view of an alternate embodiment of the electronic component from FIG. 1, shown with an H-shape core assembly;

FIG. 4B is a perspective view of the chip form from FIG. 4A, illustrating the H-shape core assembly;

FIGS. 5A-D are perspective, front elevational, side elevational and bottom views, respectively, of a preferred embodiment of the chip form from FIG. 2C;

FIGS. 6A-D are perspective, front elevational, side elevational and bottom views, respectively, of a preferred embodiment of the chip form from FIG. 3D;

FIGS. 7A-D are perspective, front elevational, side elevational and bottom views, respectively, of a preferred embodiment of the chip form from FIG. 4B;

FIGS. 8A-B are perspective views of an electronic component and a chip form, respectively, which are known in the art as the Coilcraft® 0402 Series Chip Inductor; and

FIGS. 9A-B are graphs of typical inductance versus frequency and Q-value versus frequency, respectively, showing how the components of FIGS. 4A and 3B perform comparably to the component of FIG. 8A.

### DESCRIPTION OF THE PREFERRED EMBODIMENTS

A miniature electronic component in accordance with the invention comprises a core having first and second ends with a main horizontal section extending therebetween and first and second supports for supporting the core. The first and second supports extend from respective first and second ends of the elongated core and, together with the core, define a chip form. Metalized pads are connected to the component for electrically and mechanically attaching the component to associated lands on a printed circuit board (PCB). The component further includes a wire wound about a least a portion of the main horizontal section of the core and having first and second ends which are each electrically connected to one of the metalized pads.

In one form, the supports and core define a chip form having a length ranging from 0.2 mm to 0.8 mm, a width ranging from 0.1 mm to 0.6 mm, and a height ranging from 0.2 mm to 0.6 mm. The chip form may be provided in a C-shape or an H-shape, and is preferably made of an integral piece of ceramic material. In alternate embodiments, however, the chip form may be made of a magnetic material such as ferrite or the supports and core may be made from different materials, such as a ferrite core with ceramic supports. In addition, the chip form is preferably designed with an aspect ratio of length-to-width which is generally equal to one, or approaches this value.

The wire winding preferably comprises a single layer of insulated wire wound about at least a portion of the core, with each winding of insulated wire making direct contact with at least a portion of the core. The component may also include a cover or top portion which covers at least a portion of the wire winding. Preferably, the cover has a generally flat upper surface by which the component may be picked and placed using industry standard pick-and-place equipment. In one form, the cover is made of an acrylic material and has a generally rectangular horizontal plate structure with walls extending down from the perimeter of the plate to form a box type lid structure. It should be understood, however, that the cover may be made of alternate materials, such as magnetic materials, and may have alternate shapes, such as a flat slab extending over the top of the component or a housing extending over the entire top and sides of the component. For example, the core and cover may be made of a magnetic material, such as ferrite, to allow the component to take advantage of the magnetic properties of ferrite when used in conjunction with an inductive component. In a preferred form, the electronic component, including the chip form and the cover, is designed having a length ranging from 0.2 mm to 1.0 mm, a width ranging from 0.2 mm to 0.7 mm, and a height ranging from 0.2 mm to 0.7 mm.

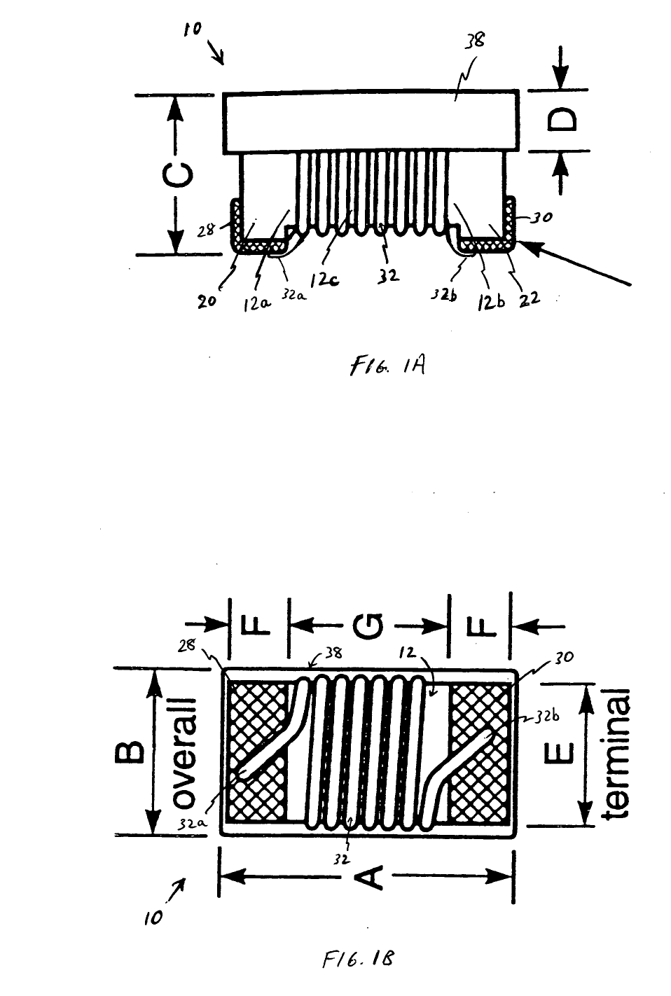

Turning now to the drawings and, particularly, FIGS. 1A-B, a low profile electronic component in accordance with the invention is shown generally at reference numeral 10. In this embodiment the component 10 comprises a low profile chip inductor having a generally rectangular shaped core 12 having first and second ends 12a and 12b with a main horizontal section 12c extending therebetween. The rectangular shape of the core 12 assists in maintaining the low profile of the component 10. For example, a round core of same or similar volume to the rectangular core shown would add height to the component, thereby making it less desirable in applications with strict height limitations. First and second supports 20 and 22 are connected to the core 12 and are preferably integral therewith. In the embodiment illustrated in FIGS. 1A-B, the core 12 and supports 20 and 22 are formed from a solid piece of ceramic.

It should be understood, however, that in alternate embodiments the supports 20 and 22 may be separate structures to strengthen the component 10 and/or allow for the supports and core to be made from different materials. For example, in an alternate embodiment, the supports 20 and 22 may be in the form of ceramic receptacles within which a ferrite core 12 is disposed, as disclosed in U.S. Pat. No. 6,690,255 B2 issued Feb. 10, 2004, which is hereby incorporated herein by reference in its entirety. This design allows the component 10 to take advantage of the magnetic properties of ferrite and the structural strength of ceramic, thereby increasing the magnetic flux density of the component and strengthening the component's ability to absorb and/or withstand mechanical forces experienced by the component 10. Alternatively, the supports may be connected to form a base to which the core 12 is connected. For example, the supports may form a ceramic base upon which a ferrite core is rested, as is disclosed in U.S. Pat. No. 6,717,500 B2 issued Apr. 6, 2004, which is hereby incorporated herein by reference in its entirety.

As illustrated in FIGS. 1A-B, the supports 20 and 22 also have respective metalized pads 28 and 30 which are used to electrically and mechanically connect the components to corresponding lands on a PCB via solder. In this way, the component can be added into a circuit located on a PCB. The metalized pads 28 and 30 are preferably bonded to the supports and L-shaped in order to strengthen the coupling between the metalized pad and the support and in order to strengthen the solder connection created between the component and the lands on the PCB. More particularly, the L-shaped metalized pads increase the amount of surface area connecting the pads to the supports and the pads to the PCB lands. This increase in surface area results in a stronger coupling between these portions of the component and the PCB. Similar benefits are achieved by making the metalized pads 28 and 30 cover the entire bottom surface of the supports 20 and 22, rather than covering only a portion of these surfaces. In the embodiment illustrated in FIGS. 1A-B, the portion of the L-shaped metalized pad covering the bottom surface of the supports is 0.18 mm in length, and the portion covering the side surface of the supports is 0.18 mm in length.

In alternate embodiments, the metalized pads 28 and 30 may be provided in different shapes and sizes. For example, in one form, the pads may be generally U-shaped pads extending over the bottom and side surfaces of the supports 20 and 22. Such a configuration can strengthen the connection between the metalized pads 28 and 30 and the supports 20 and 22, and the connection between the component 10 and the corresponding lands located on the PCB once the component is soldered thereto. For example, the additional sidewall portions of the pad increase the amount of surface area connecting the metalized pads to the supports thereby increasing the strength between the pads and the supports. Similarly, the metalized pads contain more surface area which can be soldered to the corresponding lands on the PCB, thereby increasing the mechanical strength of the connection between these two items.

In yet other forms, the metalized pads 28 and 30 may be formed like clips which are pressed onto the component. For example, the pads may be generally U-shaped or C-shaped clips which are pressed over the ends of the supports 20 and 22. More particularly, the clips may be press fit or frictionally fit onto the supports 20 and 22, or may be fixed thereto by an adhesive, or both. In other forms, the metalized pads 28 and 30 may simple comprise metal coatings applied to the bottom surfaces of the supports 20 and 22.

As illustrated in FIGS. 1A-B, the electronic component 10 also includes a wire 32 wound about at least a portion of the main horizontal section 18 of the core 12. In the embodiment shown, the wire 32 is made from an electrically conductive material such as copper and has first and second ends 32a and 32b which are electrically connected to the metalized pads 28 and 30 so that the component can be electrically connected to a circuit on the PCB when soldered thereto. More particularly, the first end 32a is connected to metalized pad 28 and the second end 32b is connected to metalized pad 30. Both ends 32a-b are flattened or pressed so as to minimize the amount each sticks out from the bottom of the metalized pads 28 and 30. This minimizes the amount metalized pads 28 and 30 will be raised from the corresponding lands on the PCB and helps ensure that both the wire ends 32a-b and the pads 28 and 30 will be coated with solder when the component is soldered to the PCB. Further, the flattened ends 32a-b allow the component 10 to rest more squarely on the PCB making placement of the component easier.

The electronic component 10 may also have a top portion or cover 38 connected to the component for providing a flattened surface with which the component can be picked up using industry standard component placement equipment, such as pick-and-place machines. Such a top portion 38 allows the component 10 to be packaged in tape and reel packaging which is widely used and preferred by purchasers of electronic components. In the embodiment shown, the top portion 38 is generally rectangular in shape with outer side walls extending downward therefrom. Such a configuration allows the top portion 38 to operate as a cover over at least a portion of the wire wound core 12, and preferably over the core 12, supports 20 and 22, and wire 32. A cover extending over the entire chip form and wire also provides the added protection of covering the current carrying wire 32 so that it cannot be inadvertently touched or shorted while carrying current.

In a preferred form, the top portion 38 is made of an acrylic and provides a large generally flat top surface for vacuum pick-and-place equipment to acquire and remove the component from a reel and place the packaged component 10 on a PCB. In alternate forms, however, the top portion 10 may be made of a magnetic material, such as ferrite, to further enhance the performance of the component 10. A ferrite top portion will significantly increase the inductance of the component 10 and lower its leakage inductance, as is discussed further in U.S. Pat. No. 6,717,500 B2 which has been incorporated herein by reference. In yet other embodiments where such enhanced performance is not needed, the top portion 38 may be made from plastic or other like materials.

Such a component can be used in a variety of applications and can even be designed for application specific uses. More particularly, the actual materials used for the various parts of the component, (e.g., the core 12, supports 20 and 22, wire 32 and cover 38), may be selected specifically for the particular application for which the component will be used. For example, in applications requiring a more sensitive coil 32, a core material having a higher permeability will be used. The higher the permeability of the material is, the higher the inductance of the component will be and the more sensitive the coil will be, albeit operating at a lower frequency. Alternatively, if the application calls for the component to operate at a higher frequency or with a less sensitive coil, materials with lower permeability values may be selected.

In a preferred form, the core 12 and supports 20 and 22 define a chip form having a length ranging from 0.2 mm to 0.8 mm, a width ranging from 0.1 mm to 0.6 mm, and a height ranging from 0.2 mm to 0.6 mm. Furthermore, the overall component will preferably have a length ranging from 0.2 mm to 1.0 mm, a width ranging from 0.2 mm to 0.7 mm, and a height ranging from 0.2 mm to 0.7 mm. These configurations will allow the component to provide inductances and Q-values which are comparable to those provided by larger components such as the Coilcraft® 0402 Chip Inductor. The exact dimensions selected and number of windings of wire 32 will determine the overall components performance parameters. For example, smaller length dimensions and/or more compressed windings of wire will force the wire 32 to form more circular or ring-shaped coils, rather than elongated spiral coils. This will increase the magnetic flux density of the component, which in turn, increases the Inductance and Reactance of the component. More particularly, the Reactance of the component may be determined by the equation:
Reactance=2π×Frequency×Inductance

Thus, the additional windings will increase the Inductance and, in turn, increase the Reactance of the component. The Q-value of the component may be determined by the equation:

$$Q = \frac{Re a ctance}{Re sistan ce}$$

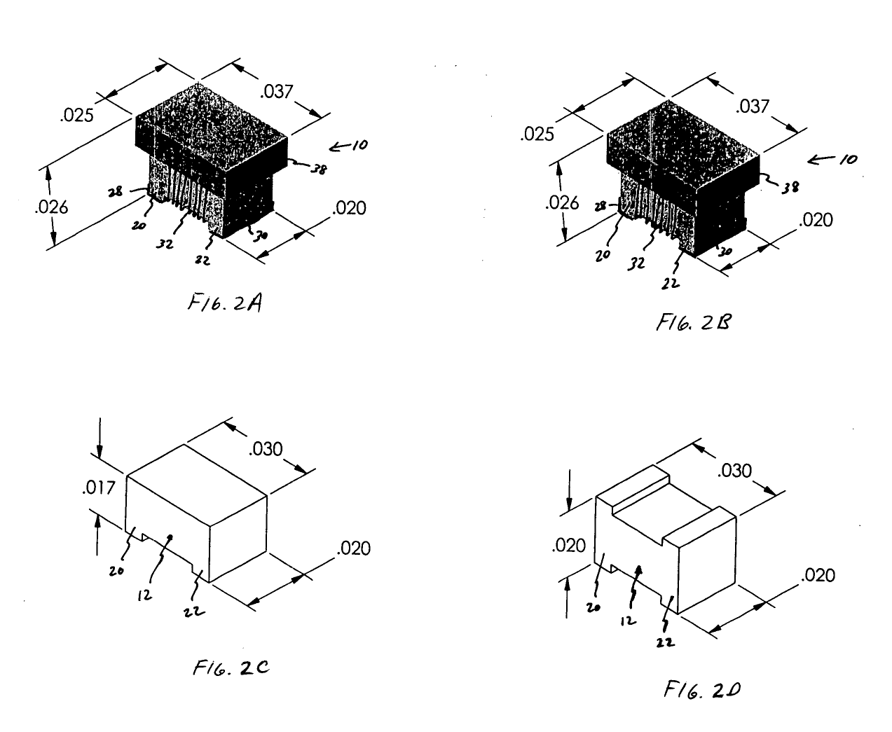

Therefore, the increase in Reactance will also result in an increase in the Q-value of the component, assuming the Resistance of the component will be maintained or lowered. In the embodiment illustrated in FIGS. 2A-D, The spacing of the wire windings may also be altered to further vary the Inductance of the component, if desired.

The following discusses specific examples of embodiments which produce components having inductances and Q-values that are comparable to larger chip inductors, such as the Coilcraft® 0402 Chip Inductor. It should be understood, however, that these embodiments are merely examples of components made in accordance with the invention and should not be interpreted as the only embodiments to which the invention applies.

FIGS. 2A-B are perspective views of embodiments of the electronic component 10, shown with a C-shape chip form and an H-shape chip form, respectively. The different chip forms or core assemblies, which are defined by the core 12 and supports 20 and 22, are illustrated in FIGS. 2C-D, respectively. More particularly, in the embodiment illustrated in FIG. 2A, the C-shape chip form of FIG. 2C is used. This chip form has a length of 0.762 mm, a width of 0.508 mm and a height of 0.432 mm. When assembled, the component 10 has an overall length of 0.940 mm, width of 0.635 mm and a height of 0.660 mm, as illustrated in FIG. 2A. In the embodiment illustrated in FIG. 2B, the H-shape chip form of FIG. 2D is used. This chip form has a length of 0.762 mm, width of 0.508 mm and height of 0.508 mm. When assembled, the component 10 has an overall length of 0.940 mm, width of 0.635 mm and height of 0.660 mm. As illustrated in FIG. 2D, the supports 20 and 22 of the H-shaped chip form extend above and below the upper and lower surfaces of the horizontal core 12. This creates a recessed portion in the upper surface of the chip form over which the wire 32 may be wound. Thus, when component 10 is assembled, the cover 38 will rest on the upper surfaces of the supports 20 and 22, rather than solely on the wire winding 32.

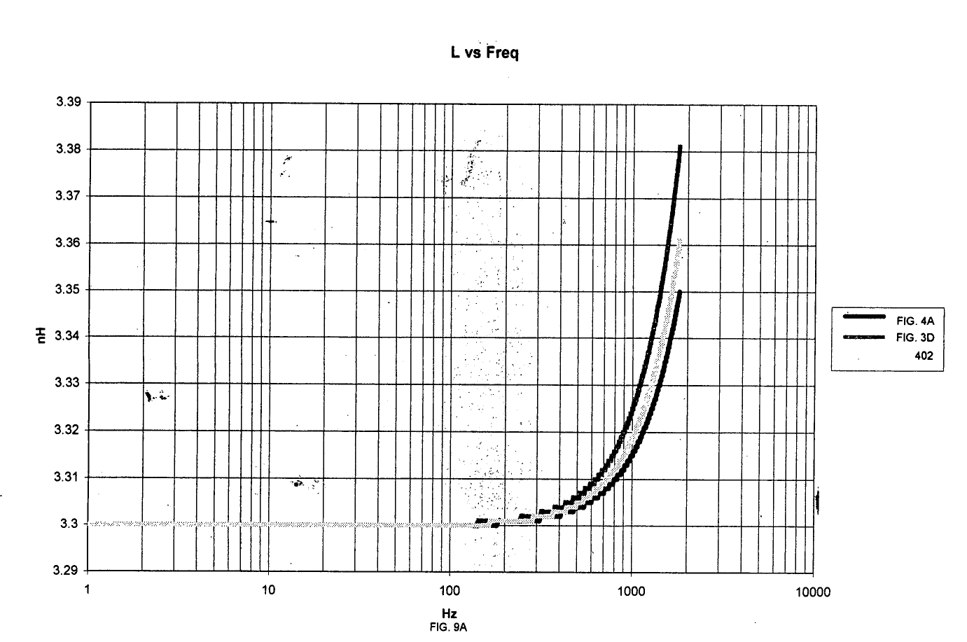

The core 12 of both chip forms maintains the same width as the supports 20 and 22, rather than decreasing in size to form a dog bone or dumbbell shape chip form as illustrated in FIGS. 8A-B. This increases the circumference of the core and the diameter of the winding, which in turn allows the component to operate comparably to the larger 0402 Chip Inductor coil component. In fact, the cross-sectional surface area of the cores illustrated in FIGS. 2A-D is larger than the cross-sectional surface area of the core of the 0402 Chip Inductor. For example, the cross-sectional area of the 0402 Chip Inductor is 0.014″ (length)×0.014″ (width), which equals 1.96×10⁴ in². The cross-section area of the core of FIG. 2C is 0.0145″ (length)×0.020″ (width), which equals 2.9×10⁴ in².

Furthermore, the aspect ratio of length to width for this embodiment approaches the value 1, and is closer to this ideal value than the 0402 Chip Inductor. More particularly, the aspect ratio of the 0402 Chip inductor of FIGS. 8A-B is:

$$Aspect Ratio = \frac{Length}{Width} = \frac{1.016 mm}{0.508 mm} = 2$$

Whereas, the aspect ratio for the component illustrated in FIGS. 2A and 2C is:

$$Aspect Ratio = \frac{Length}{Width} = \frac{0.762 mm}{0.508 mm} = 1.5$$

Such an aspect ratio yields a better Q-value for the electronic component 10.

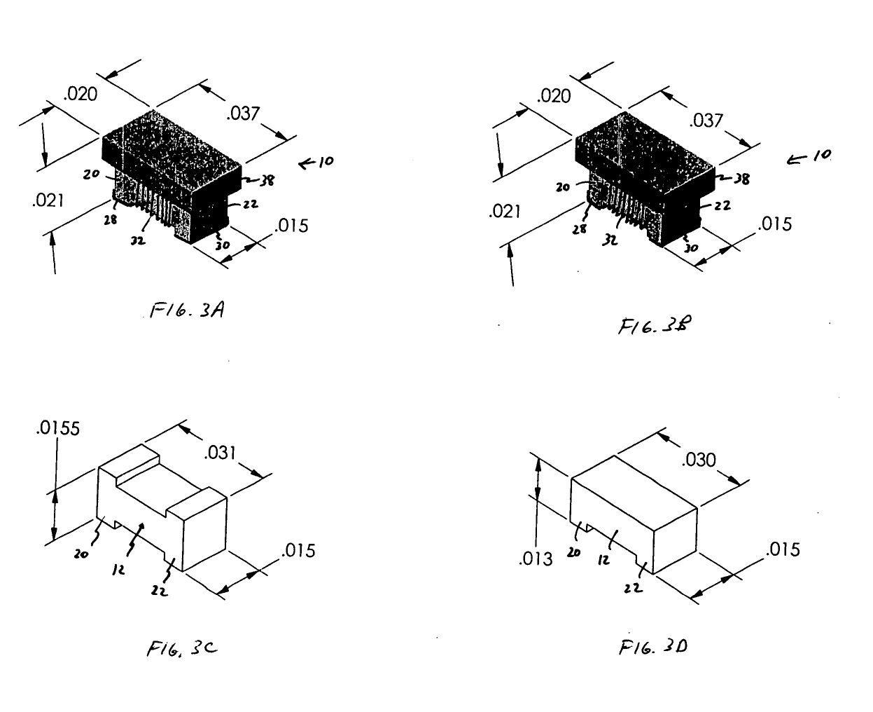

Although this embodiment is capable of producing a range of inductances and Q-values comparable to, or even better than, the Coilcraft® 0402 Chip Inductor, the overall chip form can be reduced even further and still produce a range of comparable inductances and Q-values. Examples of such a reduced chip form are illustrated in FIGS. 3A-D. More particularly, in the embodiment illustrated in FIG. 3A, the H-shape chip form of FIG. 3C is used. This chip form has a length of 0.787 mm, width of 0.381 mm and height of 0.394 mm. When assembled, the component 10 has an overall length of 0.940 mm, width of 0.508 mm and height of 0.533 mm. In the embodiment illustrated in FIG. 3B, the C-shape chip form of FIG. 3D is used. This chip form has a length of 0.762 mm, width of 0.381 mm and height of 0.330 mm. The component is wound with insulated wire preferably ranging from 42 or finer gauge copper wire. When assembled, the component 10 has an overall length of 0.940 mm, width of 0.508 mm and height of 0.533 mm. These embodiments of component 10 are capable of providing inductances between 0.67-38 nH with Q-values between 38-68 at 900 MHz and 56-100 at 1.7 GHz.

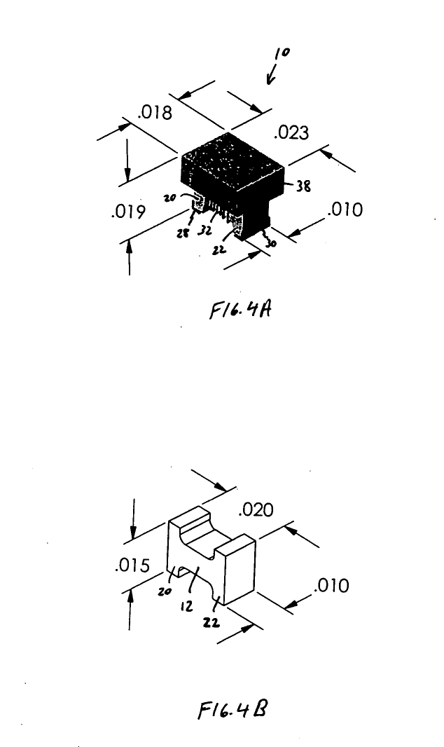

FIG. 4A is a perspective view of yet another embodiment of the electronic component 10, shown with an H-shape chip form. In the embodiment illustrated in FIG. 4A, the H-shape chip form of FIG. 4B is used. This chip form has a length of 0.508 mm, width of 0.254 mm and height of 0.3811 mm. The component is wound with insulated wire preferably ranging from 46 or finer gauge copper wire. When assembled, the component 10 has an overall length of 0.584 mm, width of 0.457 mm and height of 0.483 mm. This embodiment of component 10 is capable of providing inductances between 0.5-17 nH with Q-values between 27-45 at 900 MHz and 37-64 at 1.7 GHz.

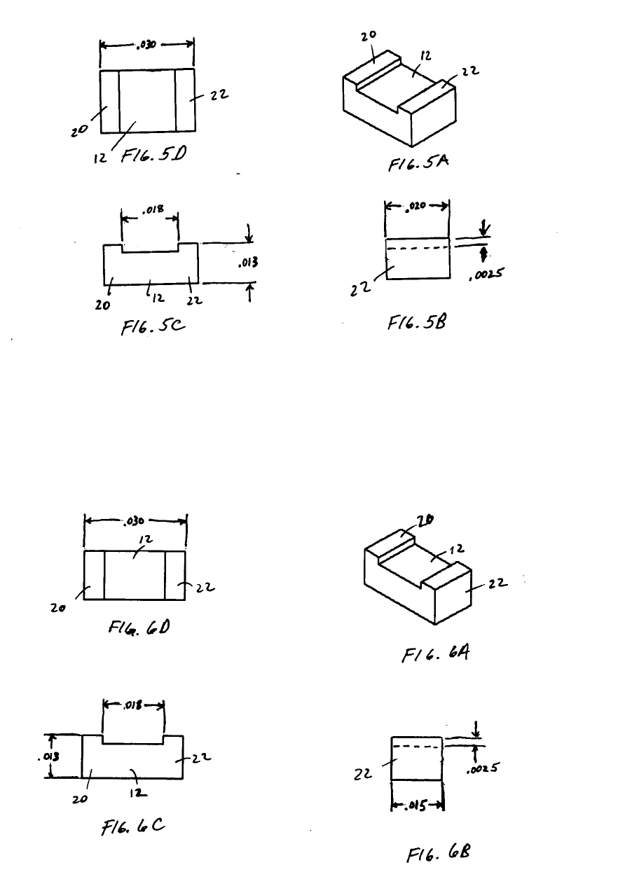

FIGS. 5A-D are perspective, front elevational, side elevational and bottom views, respectively, of a preferred embodiment of the chip form from FIG. 2C. As illustrated, the preferred chip form has a C-shape with a length of 0.762 mm, a width of 0.508 mm and a height of 0.432 mm. The main horizontal portion of the core 12 has a length of 0.457 mm, width of 0.508 mm and height of 0.267 mm, and the supports 20 and 22 have lengths of 0.152 mm, widths of 0.508 mm and heights of 0.432 mm.

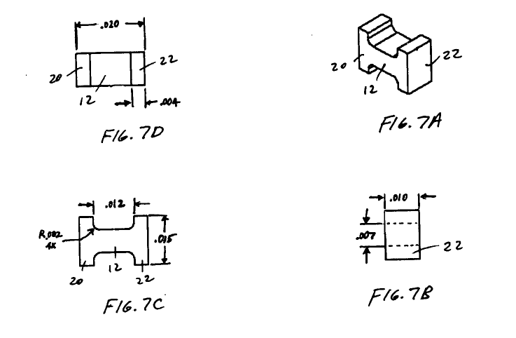

As mentioned above, however, this chip form can be further reduced in size and still provide inductances and Q-values which are comparable to larger chip inductors. A preferred embodiment of the reduced chip form is illustrated in FIGS. 3C, 3D, and 6A-D. FIGS. 6A-D are perspective, front elevational, side elevational and bottom views, respectively, of the reduced chip form from FIG. 3D. As illustrated, the preferred chip form has a C-shape with a length of 0.762 mm, a width of 0.381 mm and height of 0.330 mm. The main horizontal portion of the core 12 has a length of 0.457 mm, width of 0.381 mm and height of 0.267 mm, and the supports 20 and 22 have lengths of 0.152 mm, widths of 0.381 mm and heights of 0.330 mm. Using this chip form, the maximum value of the dimensions set forth in FIGS. 1A-B will preferably be: A=0.94 mm; B=0.51 mm; C=0.53 mm; D=0.20 mm; E=0.38 mm; F=0.15 mm; and G=0.46 mm.

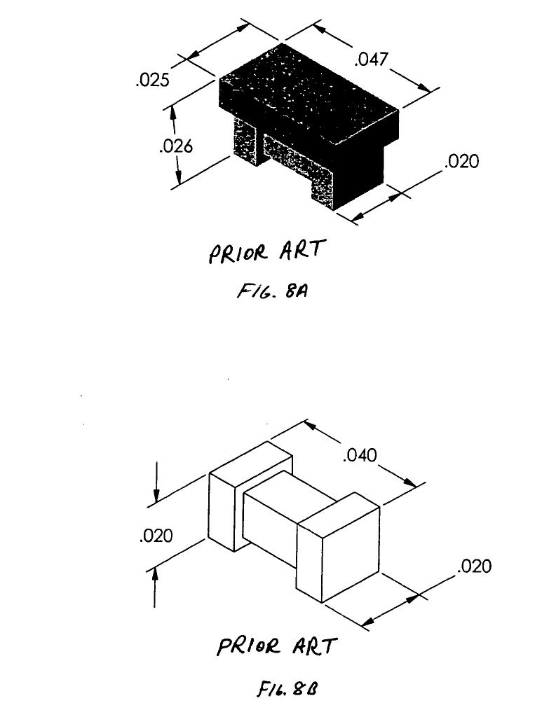

FIGS. 7A-D are perspective, front elevational, side elevational and bottom views, respectively, of a preferred embodiment of the chip form from FIG. 4B. As illustrated, the preferred chip form has an H-shape with a length of 0.508 mm, width of 0.254 mm and height of 0.381 mm. The main horizontal portion of the core 12 has a length of 0.305 mm, width of 0.254 mm and height of 0.178 mm, and the supports 20 and 22 have lengths of 0.102 mm, widths of 0.254 mm and heights of 0.381 mm. Using this chip form, the maximum value of the dimensions set forth in FIGS. 1A-B will preferably be: A=0.58 mm; B=0.46 mm; C=0.48 mm; D=0.23 mm; E=0.25 mm; F=0.10 mm; and G=0.30 mm. In addition, the ends of the core 12 are preferably flanged to increase the surface area over which the core connects to the supports and thereby increase the strength of this joint. This configuration creates a curved transition from the upper and lower surfaces of the core 12 to the supports 20 and 22, which also helps in winding the component. Although this type of joint is not shown in FIGS. 1-6, it may be implemented into any of the components if desired. In the embodiment illustrated in FIGS. 7A-D, the flanged end portions of the core have a radius of curvature of 0.051 mm.

In yet another embodiment, a smaller component may be provided using a similar configuration as the component of FIG. 4A and chip form of FIGS. 4B and 7A-D. In this embodiment, however, an H-shaped chip form is provided with a length of less than 0.292 mm, width of 0.127 mm and height of less than 0.228 mm. Using this chip form, the maximum value of dimensions set forth in FIGS. 1A-B will preferably be: A=0.29 mm; B=0.22 mm; C=0.23 mm; E=0.13 mm; F=0.05 mm; and G=0.15 mm. This embodiment of component 10 is capable of providing inductances between 0.2-8 nH with Q-values between 30-50 at 900 MHz and 50-85 at 1.7 GHz.

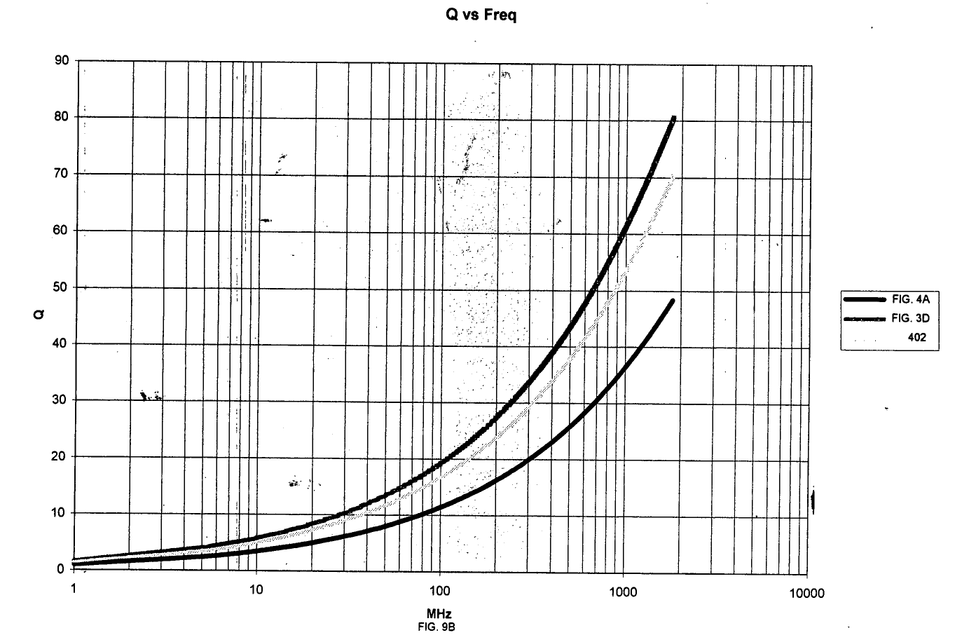

FIGS. 9A-B are graphs of typical inductance versus frequency and Q-value versus frequency, respectively, showing that the components of FIGS. 4A and 3B perform comparably, if not better than, the Coilcraft® 0402 Series Chip Inductor which is illustrated in FIGS. 8A-B. Thus, in accordance with the present invention, an electronic component is provided that fully satisfies the objects, aims, and advantages set forth above.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims.

1. A low profile surface mountable inductive component comprising:
a miniature chip form having a main horizontal portion and supports extending therefrom;
metalized pads connected to the supports for electrically connecting the chip form to a printed circuit board; and
a wire wound about a least a portion of the main horizontal portion of the chip form and having first and second ends which are connected to respective metalized pads.

2. A component according to claim 1, wherein the aspect ratio of length to width of the miniature chip form is generally equal to 1.

3. A component according to claim 1, wherein the wire winding is compressed to form generally ring shape windings to increase the magnetic flux density of the component.

4. A component according to claim 1, wherein the wire is wound about at least a portion of the main horizontal portion of the chip form in a single layer.

5. A component according to claim 1, wherein the miniature chip form comprises a C-shape or an H-shape.

6. A component according to claim 1, wherein the miniature chip form has a length ranging from 0.2 mm to 0.8 mm, a width ranging from 0.1 mm to 0.6 mm, and a height ranging from 0.2 mm to 0.6 mm.

7. A component according to claim 1, further comprising a top portion connected to the component, the top portion having a generally flat upper surface with which the component may be picked and placed using industry standard pick-and-place equipment.

8. A component according to claim 7, wherein the top portion is made from acrylic, plastic, magnetic or ceramic material.

9. A component according to claim 7, wherein the entire component has a length ranging from 0.2 mm to 1.0 mm, a width ranging from 0.2 mm to 0.7 mm, and a height ranging from 0.2 mm to 0.7 mm.

10. A low profile surface mountable inductive component comprising:
an elongated core having first and second ends;
first and second supports for supporting the core, each of the supports extending from one of the first and second core ends, the supports and core defining a chip form having a length ranging from 0.2 mm to 0.8 mm, a width ranging from 0.1 mm to 0.6 mm, and a height ranging from 0.2 mm to 0.6 mm;
metalized pads provided on the supports for electrically connecting and mounting the supports to the printed circuit board; and
a wire wound about at least a portion of the core and having ends electrically connected to the metalized pads of the supports.

11. A component according to claim 10, wherein the chip form has a C-shape or an H-shape.

12. A component according to claim 10, further comprising an aspect ratio of length-to-width which is generally equal to one.

13. A component according to claim 10, wherein the wire winding comprises a single layer of insulated wire wound about at least a portion of the core, with each winding of insulated wire making direct contact with at least a portion of the core.

14. A component according to claim 10, wherein the component further comprises a cover covering at least a portion of the wire winding, the cover having a generally flat surface by which the component may be picked and placed using industry standard equipment.

15. A component according to claim 14, wherein the cover is made of an acrylic, a plastic, a ceramic or a magnetic material.

16. A component according to claim 14, wherein the entire component has a length ranging from 0.2 mm to 1.0 mm, a width ranging from 0.2 mm to 0.7 mm, and a height ranging from 0.2 mm to 0.7 mm.

17. A component according to claim 10, wherein the core and supports are integral to one another and made from a ceramic or magnetic material.

18. A low profile surface mountable inductive component comprising:
an elongated core having first and second ends;
first and second supports for supporting the core, each of the supports extending from one of the first and second core ends, the supports and core defining a form;
metalized pads provided on the supports for electrically connecting and mounting the supports to the printed circuit board;
a wire wound about at least a portion of the core and having ends electrically connected to the metalized pads of the supports; and
a cover covering at least a portion of the wire winding, the cover having a generally flat surface by which the component may be picked and placed using industry standard equipment, the component having a length ranging from 0.2 mm to 1.0 mm, a width ranging from 0.2 mm to 0.7 mm, and a height ranging from 0.2 mm to 0.7 mm.

19. A component according to claim 18, wherein the core and supports define a chip form having a C-shape or an H-shape.

20. A component according to claim 18, wherein the cover is made of an acrylic, a plastic, a ceramic or a magnetic material.
